(19) United States
(12) Patent Application Publication
(10) Pub. No.: US 2011/0051454 A1
(43) Pub. Date: Mar. 3, 2011

(54) LIGHT-TRANSMISSION APPARATUS AND METHOD TO PRODUCE SAME

(75) Inventors: Juergen Wolf, Schloeben (DE); Robert Liebold, Jena (DE); Konrad Weymar, Jena (DE)

(73) Assignee: JENOPTIK LASER GMBH, Jena (DE)

(21) Appl. No.: 12/920,073

(22) PCT Filed: Feb. 24, 2009
(86) PCT No.: PCT/EP2009/001289

§ 371 Date: Nov. 16, 2010

(30) Foreign Application Priority Data
Feb. 27, 2008 (DE) 102008011525.8

(51) Int. Cl. H01S 3/00; G02B 6/10; G02B 6/02

(52) U.S. Cl. 362/553; 385/137; 362/581

(57) ABSTRACT

To produce a light transmission apparatus with a reference objective, an optical fiber having a light transmission surface and a retaining element, the invention proposes the production of a cutout in the retaining element by molding of one outer contour section of the optical fiber. The cutout is used for radial, form-locked control of a guide section of the optical fiber which slides in the cutout with respect to the retaining element in order to change the position of the light transmission surface. The locking of the layers of the retaining element and of the light transmission surface with respect to the reference objective concludes the positioning procedure of the light transmission surface with respect to the reference objective.

The invention relates to a method for producing a light transmission apparatus according to the preamble of Claim 1 and a light transmission apparatus according to the preamble of Claim 20.

### INTRODUCTION

The coupling of light which is emitted by an optoelectronic semiconductor component—such as a laser diode—into an optical fiber is typically performed via a light transmission surface as the coupling surface, which is situated on a first end of the optical fiber, for example.

To achieve an optimum coupling efficiency, the light transmission surface must be positioned in relation to an optical reference object—such as a lens which focuses the light beam bundle. To obtain the optimum coupling efficiency, the coupling surface must additionally be fixed in this location in relation to the reference object.

Four degrees of movement freedom of the coupling surface with respect to the reference object play an overriding role during the positioning: three translational and one rotational. In a Cartesian coordinate system, these are the two directions x (horizontal) and y (vertical) transverse to the fiber axis, the direction z (axial) parallel to the fiber axis, and the rotation ⊖ around an axis parallel to the fiber axis (alignment of the fiber azimuth).

The latter is significant in particular if the fiber has a non-rotationally-symmetric geometry to improve its optical properties and/or the coupling efficiency. Thus, the light transmission surface of a fiber end surface can have a wedge-shaped or hyperbolic form, for example, in order to make the coupling of light beam bundles which are highly divergent in an axial direction easier in particular. In addition, fibers—at least in the coupling area—may have a rectangular core, which is adapted to the rectangular cross-section of a beam bundle. In addition, polarization maintaining fibers have non-rotationally-symmetric cross-sectional profiles of the index of refraction ellipsoid.

### PRIOR ART

The technical requirement during the positioning of the light transmission surface of an optical fiber with respect to a reference object comprises the execution of high-precision relative movements, which are controllable with high precision, in the x, y, and z directions and optionally in the ⊖ direction, which ends with the elimination of all degrees of movement freedom in the optimum relative position of both objects by their fixation relative to one another.

Positioning and fixing methods supplement one another optimally if they ensure a high coupling efficiency having long-term stability, which may be implemented rapidly and cost-effectively.

It is proposed in the patent specification U.S. Pat. No. 6,529,535 B2 that an end section of the optical fiber be embedded in a materially bonded manner in a ferrule implemented as a hollow cylinder, and this ferrule be fixed after completed positioning on four support elements using laser welding.

To execute the positioning movement, it is proposed in patent specification U.S. Pat. No. 6,690,865 B2 that the optimum relative location of light transmission surface (fiber end surface) and reference object (laser diode) be ascertained by two separate movement patterns—a first one in the xy plane and a second one in the z direction—of the ferrule in relation to the reference object.

The combination of both methods has the disadvantage that, with the elimination of one degree of freedom by fixation of ferrule-fiber unit and laser diode to one another, all degrees of freedom are eliminated and no realignment is still possible in the direction of at least one second degree of freedom after the elimination of a first.

This is also true, of course, for the case in which the ferrule is dispensed with and the fiber end section is solely positioned using the light transmission surface (coupling surface) in relation to the laser diode. For this reason, it is proposed in some publications that, using an auxiliary element, the movement freedom of the coupling surface be restricted at least in one transverse direction x or y, preferably both, with respect to this auxiliary element, while the other degrees of movement freedom, in particular in the z direction and ⊖ direction, are maintained for positioning the light transmission surface.

Such auxiliary elements comprise support rests (U.S. Pat. No. 4,955,683; U.S. Pat. No. 5,469,456), V-trenches (U.S. Pat. No. 6,078,711), rings (U.S. Pat. No. 6,078,711), and ferrules (U.S. Pat. No. 4,668,045).

The auxiliary elements according to the prior art have the disadvantage of the circumstance that their capability for guiding the fiber in the fiber axial direction (z direction) is inadequate in that residual play remains in the direction transverse to the z direction. A separation of the degrees of movement freedom into two groups independent of one another, namely the group of the transverse movement in the directions x and y and the group of the axial movements in the directions z and ⊖, which may be eliminated sequentially in the positioning process, is thus not ensured.

The positioning of the light transmission surface proves to be particularly critical with respect to its rotation around the fiber axis, which is required if the optical fiber is implemented as non-rotationally-symmetric in the coupling area: in the event of transverse play, the location of the rotational axis is no longer identical to the fiber axis, but rather lies beside the fiber axis in the tolerance range of the guide. A rotation of the fiber end surface or coupling surface is thus always accompanied by an undesired movement in the transverse direction, which subsequently must be compensated for again, not without generally resulting in a renewed alignment of the fiber azimuth.

This undesired complex alignment procedure relates in particular to optical fibers in which the light transmission surface on a fiber end surface is implemented as partially wedge-shaped or cylindrical—for example, in the form of a ground cylindrical lens—as described, for example, in the publications U.S. Pat. No. 3,910,677, U.S. Pat. No. 4,766,705, U.S. Pat. No. 5,845,024, U.S. Pat. No. 5,872,881, U.S. Pat. No. 6,301,406 B1, and U.S. Pat. No. 6,597,835 B2.

### OBJECT OF THE INVENTION

The object of the invention is to describe an auxiliary element for positioning the light transmission surface of an optical fiber with respect to a reference object—such as a laser diode—which allows a location change of the light transmission surface in and/or around the fiber axial direction without play in the transverse direction.

Furthermore, it is the object of the invention to allow simple and cost-effective production of the auxiliary element.

In addition, it is the object of the invention to describe methods for positioning the light transmission surface of an optical fiber with respect to a reference object, in which a first group of transverse degrees of movement freedom and a second group of axial degrees of movement freedom may be used and eliminated individually independently of one another.

Finally, it is the object of the invention to describe a light transmission apparatus and a method for the production thereof, in which the positioning of the light transmission surface of an optical fiber with respect to a reference object can be performed in a particularly simple, rapid, and cost-effective way.

### DESCRIPTION OF THE INVENTION

The object is achieved according to the invention by a method for producing a light transmission apparatus according to Claim 1 and a light transmission apparatus according to Claim 20.

According to the invention, a guide section of the optical fiber is situated in the radially form locked guide of a recess of a auxiliary element, which is referred to as a holding element, the recess being produced by molding an outer contour section of the optical fiber.

The molding allows a simple and cost-effective production of the holding element according to the invention. In particular, it allows a high-precision production of the recess, which is used to guide the optical fiber. A radial form fit between recess and guide section of the fiber is thus optimally ensured by manufacturing.

A recess provided for guiding the fiber, which was not molded on the fiber to be positioned, will always have a positive cross-sectional tolerance in manufacturing, in order to be able to thread any fiber of a batch of multiple fibers, which are identical in principle, of cross-sectional dimensions which vary slightly due to manufacturing, at least partially in or through the recess. As a result, a transverse play of the fiber section lying in the recess of the holding element is to be expected at least for some fibers because of a lack of a radial form fit. This is the case with all ferrules according to the prior art, which have not been produced adapted individually to each fiber. In contrast to the known ferrules, according to the invention, a holding element adapted individually to each fiber is produced by the molding of the recess provided for guiding in the holding element to each fiber itself, a radial form fit between recess and fiber being able to be ensured at least partially by the production. The radially form fitting guide in the holding elements ensures an extremely low-play, essentially play-free mounting of the guide section, a change of the location of the light transmission surface in the fiber axial direction and/or around the fiber axis being able to be performed essentially without a transverse movement when the holding element is fixed.

Through the separation according to the invention of the degrees of movement freedom into two groups—a first group of transverse degrees of movement freedom and a second group of axial degrees of movement freedom—a simpler, rapid, and thus more cost-effective positioning process of the light transmission surface with respect to the reference object is ensured, in that the first group of transverse degrees of movement freedom is used through a movement of the holding element including guide section of the optical fiber in at least one direction perpendicular to the fiber axis and the second group of axial degrees of movement freedom is used by the execution of a sliding movement of the guide section of the optical fiber in the recess of the holding element. Both groups of degrees of movement freedom may be eliminated individually and independently of one another: the first group of transverse degrees of movement freedom by the fixation of the location of the holding element in relation to the reference object and the second group of axial degrees of movement freedom by the fixation of the location of the light transmission surface in relation to the holding element. Each individual one of the two fixation methods can thus be adapted and optimized independently of the respective other one to the differing fixation conditions in the light transmission apparatus. The holding element can also be moved in the z direction if needed, the optical fiber sliding in the recess without the distance of the light transmission surface to the reference object changing. Thus, for example, the distance of the holding element from the reference object can be set, so that a joint gap of optimal thickness results between both components. The distance of the holding elements from the reference object in the z direction can also be kept constant independently of the location of the light transmission surface in various light transmission apparatuses. A reliable result of the production according to the invention of the light transmission apparatus can be ensured both with respect to the positioning precision and both the short-term and also the long-term fixing precision.

If the guide section of the fiber which is guided in the holding element has an essentially constant cross-section in the fiber axial direction, the guide section of the fiber can be displaced in the recess of the holding element in the direction of the fiber axis (z direction), without the location of the light transmission surface experiencing a change in the x or y direction. If the guide section of the fiber guided in the holding element additionally has a non-rotationally-symmetric cross-section, the location of the light transmission surface can also be kept constant in the rotational (⊖) direction.

If the guide section of the fiber which is guided in the holding element has a rotationally-symmetric, for example, cylindrical cross-section, the guide section of the fiber in the recess of the holding element can be rotated around a rotational axis which corresponds to the fiber axis, without the location of the light transmission surface experiencing a change in the x or y direction. If the guide section of the fiber which is guided in the holding element additionally has a variable cross-section in the fiber axial direction, the location of the light transmission surface can also be kept constant in the z direction. In this context, the positioning according to the invention of the light transmission surface proves to be particularly advantageous in regard to its rotation around the fiber axis in the case in which the light transmission surface used as the light coupling or outcoupling area or the light-guiding areas of the fiber in the coupling or outcoupling area are not implemented as rotationally symmetric with respect to the fiber axis. Without transverse play in the guide, the location of the rotational axis is identical to the fiber axis, which allows rapid and cost-effective positioning of the fiber azimuth.

This relates, on the one hand, to optical fibers having fiber end surfaces which achieve a non-rotationally-symmetric lens effect because of geometry, for example, ground cylindrical lenses on the fiber end surface or cylindrical lenses attached to the fiber end surface, whose orientation at an angle to the reference object must be aligned for optimum transmission. On the other hand, this relates to optical fibers which at least partially have a non-rotationally-symmetric fiber core, for example, a fiber core having rectangular cross-section, which is particularly suitable for coupling, guiding, and/or beam shaping of non-rotationally-symmetric light beam bundles. The optical fibers of fiber lasers also fall into this category. In addition, optical fibers having polarization maintaining properties and optical fibers having multiple fiber cores, in particular a double core, require positioning of the fiber azimuth.

In general, the light transmission apparatus according to the invention is neither restricted to the use of a specific optical fiber nor to the conduction of light of a specific wavelength. Thus, the optical fibers may at least partially have a photonic crystal structure and/or be part of a fiber laser and/or be part of a branched fiber structure. The guided light can belong to the visible, ultraviolet, and/or infrared spectral ranges.

Of course, the invention is also applicable to fibers which may conduct electromagnetic radiation from a wavelength range beyond the ultraviolet and/or infrared spectral ranges.

The light transmission apparatus is also not restricted to the use of a single fiber, a single holding element, or a single reference object. Thus, apparatuses having multiple optical fibers in a series or in a bundle may also be produced according to the invention, and having multiple holding elements and/or multiple reference objects in a series and/or stack configuration.

In general, an optical fiber comprises three components: the light-guiding core, a light-opaque cladding, which adjoins it to the outside, and a coating, which adjoins thereon to the outside—such as a polymer coating—which provides the fiber with flexibility and breakage protection, which it would not have without it. The coating comprises plastic, for example, but can also comprise metal.

It is advantageous for the method according to the invention if the outer contour section of the optical fiber to be molded is formed by an outer lateral surface of the fiber cladding, because typically the outer lateral surface of the fiber cladding is implemented as more cylindrical in cross-section and more concentric with respect to the fiber core and/or the fiber axis than the outer lateral surface of the fiber coating situated outside the fiber cladding.

For this purpose, if necessary the section of the fiber to be molded must be exposed by removing the coating before the molding process for the production of the recess.

On the other hand, of course, it can also be advantageous to partially use the already existing fiber coating, which was molded on the fiber cladding during its production, as the holding element according to the invention, in that a coating section, which extends in the fiber axial direction and radially encloses the fiber cladding in a form fitting manner, is separated or detached from the remaining coating and from the fiber cladding.

For the sake of completeness, it is also to be noted that, of course, although it is less preferable, outer lateral surface sections of other fiber components may also be molded, such as the fiber core or the fiber coating.

Although the material used during the molding is not restricted to a specific material according to the invention, specific materials or substances are nonetheless preferable for the molding and the implementation of the recess. A substance which changes its state during and/or after the molding is particularly preferably used for the molding, for example, by changing from a state of increased deformability (lower dimensional stability) into a state of reduced deformability (higher dimensional stability). In general, this state change includes a reduction of the viscoplasticity of the substance, which can be essentially characterized, for example, by a reduction of the viscosity or by a reduction of the plasticity. This change can be generated isothermally—for example, induced chemically or by radiation—or also because of temperature; both by temperature increase—for example, upon the curing of an adhesive—and also by temperature reduction—for example, upon the solidification of a solder below its solidus temperature.

In a first state of high viscoplasticity, the substance is adapted during the molding to the outer contour section of the fiber to be molded, optionally with application of increased temperature or elevated pressure. In a second state of low viscoplasticity, the recess produced by molding, and/or the holding element or one or more parts thereof, is essentially dimensionally-stable—at least more stable in relation to thermal and/or mechanical influences against a shape change than in the state of the molding. A reduction of the viscoplasticity can generally also be referred to as solidification. In summary, it is advantageous for the method according to the invention if the production of the holding element and the molding of the recess includes the solidification of a substance which encloses and/or contacts the outer contour section. The enclosure does not have to be around 360° of the entire circumference, but rather can be restricted to the amount required to set up a radial form fit, for example, around 190° of the partial circumference.

Although the solidifying substance is not restricted to a specific material, the substance which solidifies during or after the molding preferably contains an adhesive or a solder, in particular an organic adhesive or a metal solder, in which the solidification is essentially based on viscous state changes. The solidifying substance preferably essentially completely comprises an adhesive or a solder.

The recess according to the invention is less preferably molded on the outer contour section of the fiber by essentially solely plastic material deformation, for example, by the exertion of one or more forces on a holding element of structurally-related elasticity. The holding element passes from a first shape with a lack of form fit in the force-free state through plastic deformation into a second shape with existing form fit in the force-free state. Because of the intrinsic tensions in the holding element which possibly exist after plastic deformation, under certain circumstances there is also a friction connection, although slight, between the holding element and the optical fiber.

The holding element preferably comprises the solidifying substance essentially completely or at least predominantly with respect to its volume and/or mass.

Less preferably, because it is more complex, the holding element has other substances in addition to the solidifying substance, which do not directly participate in the molding of the outer contour section. Nonetheless, it can be advantageous for the molding process and for the stability of the holding element after completion of the molding, for example, if a filler which mechanically stabilizes the curing adhesive is used.

The sliding movement according to the invention of the guide section of the optical fiber in the recess of the holding element presumes that no material bond and at most a limited, preferably slight friction connection exists between the molded fiber section and the holding element produced by molding. To avoid the contrary state, the molded outer contour section of the fiber can be subjected to a passivation method before the molding, which is provided for the purpose of preventing the occurrence of a material bond of the optical fiber with the surrounding substance or weakening a material bond of the optical fiber with the surrounding substance.

Such passivation methods include wetting using a parting agent—for example, liquid or powdered—the application of a coating which has no or only slight adhesion to the outer contour section and forms a material bond with the molding substance, and the application of a coating which has an adhesion to the outer contour section and does not form a material bond with the molding substance.

To remedy a possible contrary state of existing material bond or friction connection between holding element and fiber, it is proposed that it be weakened or canceled out by application of a removal method. Removal methods of this type include the application of at least one force, in particular a static or dynamic traction, compression, or torsion force, the application of ultrasound, the change of climactic environmental conditions, in particular the humidity, the temperature, and/or the pressure. The latter can occur already during the molding process, for example, upon the cooling after or during a dimension-stabilizing solidification, for example.

The method according to the invention for producing the transmission apparatus is characterized by the fixations of the locations of the holding element and the light transmission surface with respect to the reference object after completed orientation of the light transmission surface with respect to the reference object.

It is sufficient, because of the radially form fitting guide of the guide section, which is preferably situated close to the light transmission surface—for example, at a distance of less than 100 times, particularly preferably less than 20 times the fiber cladding diameter—, to connect the fiber to a fixing section using a component whose location is fixed in relation to the reference object. This component can be the holding element, a carrier which forms a preferably materially-bonded holding assembly with the holding element, or the fiber feed-through in the frame of a housing and/or the frame itself, which is fastened on the same housing baseplate as the reference object.

These fixations preferably each include at least one material bond between the fixation partners by welding and/or participation of at least one joining agent, in particular a solder and/or an adhesive.

During the fastening of a fixing section of the optical fiber on the holding element, it can be advantageous if the fixing section and guide section at least partially have an overlap and the fastening of the fixing section at least partially occurs in the recess of the holding element.

As already indicated, the light transmission apparatus according to the invention can be situated completely outside, or partially or completely inside a shared housing. In particular, the reference object, the holding element, and the optical fiber may be at least partially situated in a shared housing and fastened on a housing component of the shared housing, in particular in a housing wall, a housing floor plate, a housing cover, or a feed-through.

At least one of all mentioned method steps which are essential to the invention or related to the invention, in particular the molding, the location change, and/or at least one of the fixations, may be performed between two wall sections of the housing.

In addition, the mechanical coupling of a displacement and/or rotational apparatus, which is to be set up for the location change of the light transmission surface with respect to the holding element, can be performed on a coupling section of the optical fiber which is situated outside the area which is provided for the formation of a housing inner volume.

The invention is explained in greater detail hereafter on the basis of an exemplary embodiment. In the figures:

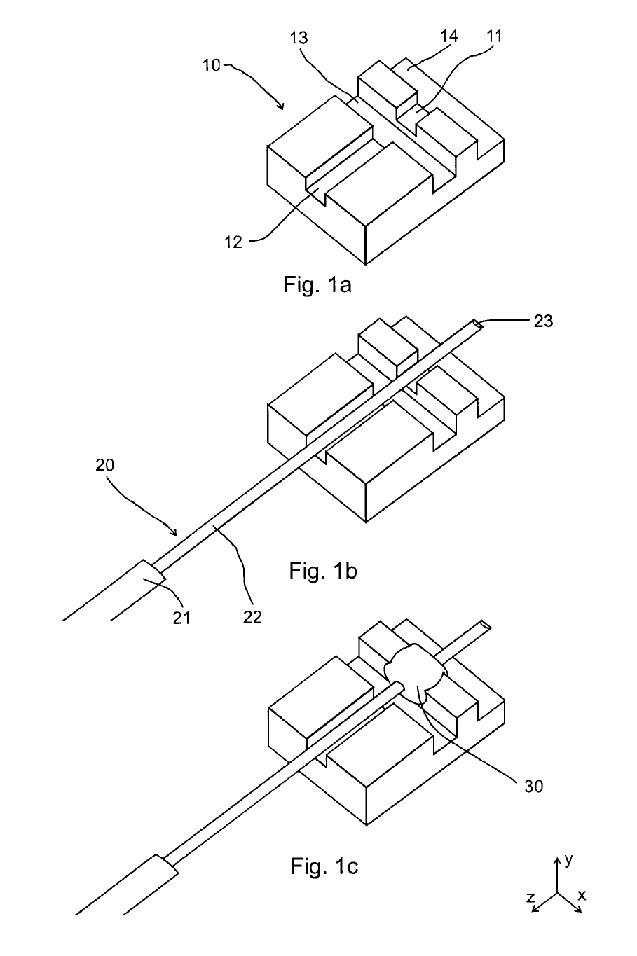

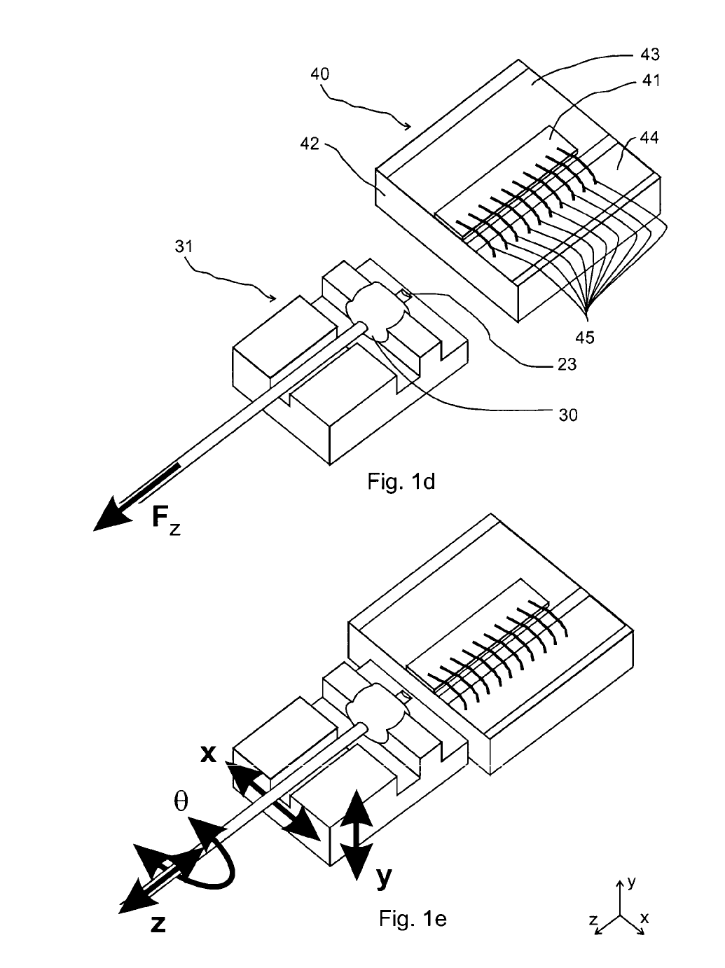

FIG. 1a shows a carrier for the holding element of the production according to the invention of a first exemplary embodiment of a light transmission apparatus,

FIG. 1b shows the carrier having an optical fiber,

FIG. 1c shows the holding assembly made of carrier and holding element having optical fiber after completed molding,

FIG. 1d shows a laser diode assembly and the application of a removal method to cancel out an existing connection between the molded section of the optical fiber and the holding element,

FIG. 1e shows the application of a positioning method for the coupling surface of the optical fiber in relation to the laser diode assembly,

FIG. 1f shows the finished light transmission apparatus according to the invention, having the fixations of the locations of the holding element and the light transmission surface in relation to the laser diode assembly,

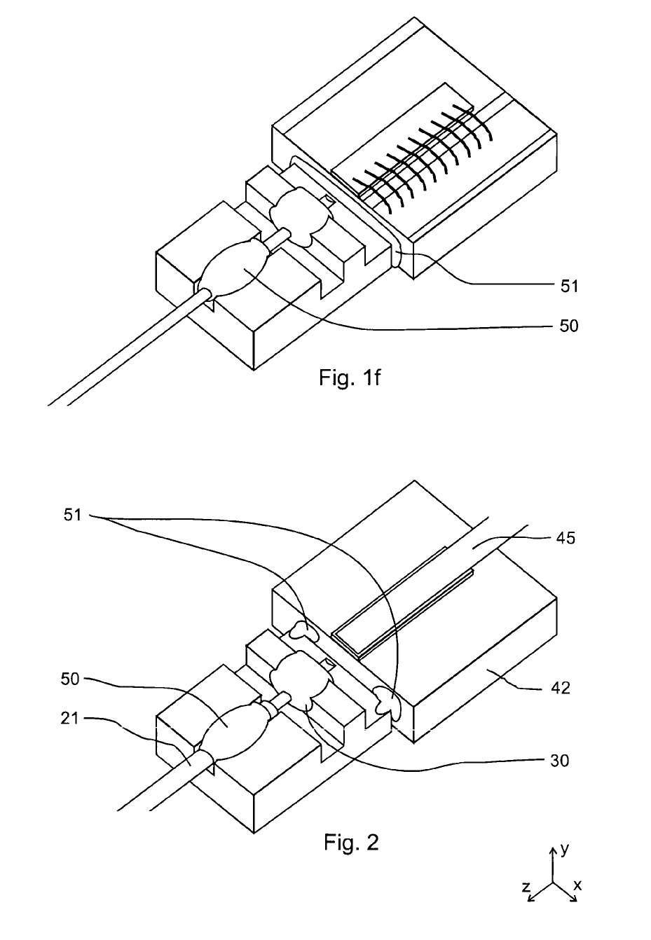

FIG. 2 shows a second exemplary embodiment of a light transmission apparatus produced according to the invention,

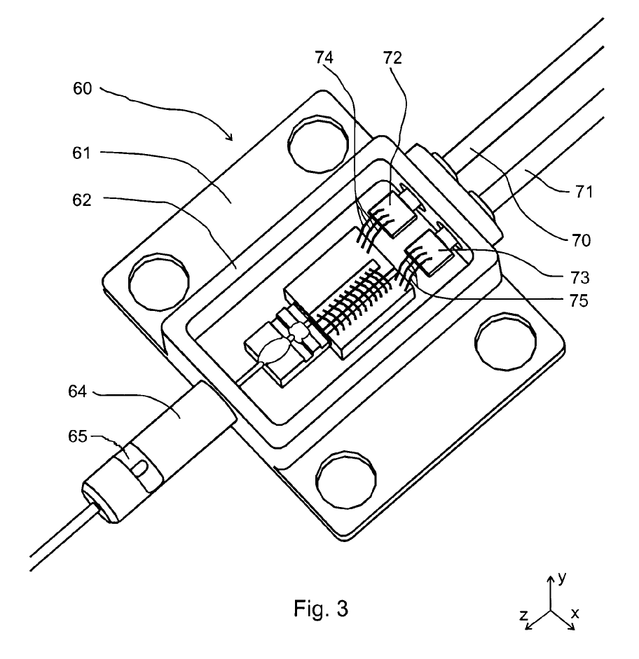

FIG. 3 shows a third exemplary embodiment of a light transmission apparatus produced according to the invention.

All exemplary embodiments relate to a light transmission apparatus, in which the reference object is a light-emitting laser diode (41), and the light transmission surface is the fiber end surface (23), via which the light beam bundle emitted by the laser diode (41) is largely coupled into the optical fiber (20). However, this does not mean that the invention is restricted to a special reference object or a special light transmission surface.

In general, the reference object can be an arbitrary light emission apparatus, light transmission apparatus, or light reception apparatus known in the prior art. The light emission apparatuses preferably coming into consideration for the invention include, in addition to laser diodes, edge-emitting and surface-emitting semiconductor lasers of any type, light-emitting diodes (LEDs) made of inorganic and/or organic material, and solid state and fiber lasers. The light transmission apparatuses preferably coming into consideration for the invention include optical fibers and lenses as well as lens apparatuses of any type, in particular collimation and focusing optics. The light reception apparatuses preferably coming into consideration for the invention include light detection apparatuses, in particular of the photoelectric principle—such as photodiodes—and/or photo-thermal principle, as well as photovoltaic elements—for example, solar cells—and lasers which use the received light as pump light.

In general, the light transmission surface can be situated at any location of the optical fiber, not only on the end surface but rather on any arbitrary external surface of the optical fiber along its axis.

### First Exemplary Embodiment

In a first exemplary embodiment, a carrier (10) comprising glass is used to receive the holding element (30). As FIG. 1a shows, the carrier (10) has a longitudinal groove on its upper side, which is divided by a transverse groove (13) running perpendicular thereto into a first longitudinal groove section (11) and a second longitudinal groove section (12). In extension of the longitudinal axial direction of the first longitudinal groove section (11), the carrier additionally has a projection (14) in the direction facing away from the second longitudinal groove (12), which is offset in relation to the upper side of the carrier toward a lower side diametrically opposite to the upper side.

An optical fiber (20) is freed of its coating (21) on a length which at least corresponds to that of the longitudinal groove of the carrier (10), so that on this length the lateral surface of the fiber cladding (22), which comprises glass, forms the outer contour of the optical fiber (20).

The coating-free part (22) of the optical fiber (20) extends over an end section of the optical fiber (20), which comprises a fiber end surface (23) having ground cylindrical lens as the light transmission surface. As may be inferred from FIG. 1b, the coating-free part (22) of the optical fiber (20) is partially introduced into the longitudinal groove, the fiber end surface (23) being situated outside the longitudinal groove in the direction of the projection (14). The section of the optical fiber (20) positioned in the longitudinal groove can rest on the groove floor; however, it preferably floats between the groove walls. To produce the holding element (30), an adhesive volume, such as an adhesive drop, is introduced into the first longitudinal groove (11), the drop at least partially flowing around the fiber section located therein and adapting itself to the shape of the outer contour section which it flows around (FIG. 1c). The transverse groove (13) and the projection (14) limit a capillary flow of the adhesive beyond the first longitudinal groove section (11) because of their enlarged free space between fiber (20) and carrier therein. In particular, the transverse groove (13) prevents flowing of the adhesive into the second longitudinal groove section (12). The projection (14) prevents flowing of the adhesive onto a front face of the carrier (10), which is located oriented perpendicularly to the fiber axial direction on the projection (14) and is provided as a joint surface for a fastening of the carrier (10).

The adhesive is solidified by suitable means, for example, the application of heat and/or light, and forms a holding element (30) for the optical fiber (20) by its cohesion. Through the adhesion of the adhesive, a material bond exists for the holding element (30) to both the outer contour section of the optical fiber (20) and also to the carrier (10), the adhesion on the glass of the optical fiber (20) being less than on the glass of the carrier (10), because only the latter was pretreated with an adhesion-mediating primer.

The adhesion-mediating primer is not required in every case, because in the event of possibly comparable adhesion between the joint partners, the adhesion force between optical fiber (20) and holding element (30) is less, due to the smaller interface, than the adhesion force between holding element (30) and carrier (10).

Alternatively, a separately manufactured holding element made of a first adhesive can also be fastened using a second adhesive in the first longitudinal groove section (11).

By application of a traction force Fz in the fiber axial direction (z direction), the connection existing between the holding element (30) and the molded outer contour section of the optical fiber (20) is detached and a guide section of the optical fiber (20) is guided in a radially form fitting manner in the recess in the holding element (30) which is defined by the molded section (FIG. 1d). By applying corresponding traction/compression forces to the optical fiber (20) in the fiber axial direction (z direction) and/or corresponding torsion forces around the fiber axis in the azimuth direction (⊖ direction), the guide section can be moved by sliding in the recess and thus the position of the fiber end surface (23) with respect to the holding elements (30) and/or with respect to the carrier (10) can be changed (FIG. 1).

The holding assembly (31) comprising carrier (10) and holding element (30) can additionally be displaced in the radial direction, in Cartesian coordinates: in the x and y directions, transversely to the fiber axis, the fiber end surface (23) also being displaced in these directions.

In sum, both positioning processes, that for the axial direction z and ⊖ and that for the transverse directions x and y, are capable of optimally aligning the location of the fiber end surface (23), in particular the angle of the ground cylindrical lens, in relation to the beam exit surface of the laser diode (41) in the laser diode assembly (40) with respect to the maximum optical power which can be coupled in.

In the laser diode assembly (40), the laser diode (41) is fastened using a first electrical contact surface on a first electrical terminal surface (43) of an electrically insulated heat conduction body (42). The electrical terminal elements (45) connect a second contact surface of the laser diode (41), which is diametrically opposite to the first electrical contact surface, to a second electrical terminal surface (44) of the heat conduction body (42), which is electrically disconnected from the first electrical terminal surface. After completed alignment by the described positioning of the fiber end surface (23) with respect to the laser diode (41), the location of the fiber end surface (23) with respect to the laser diode (23) is fixed. This is performed, as shown in FIG. 1f, by setting up a material bond (50, 51) in each case between optical fiber (20) and the carrier (10) and between the carrier (10) and the laser diode assembly (40).

For this purpose, on the one hand, an adhesive volume (50), such as an adhesive drop, is introduced into the second longitudinal groove section (12) of the carrier (10), this drop flowing around the fixing section of the optical fiber (20) located therein and adapting itself to its outer contour. By solidification of the adhesive and its adhesion and cohesion forces, a material bond is achieved between carrier (10) and optical fiber (20) having a fixation of the location of the fiber end surface (23) with respect to the holding elements (30). The fixation of the location of the holding element (30) with respect to the laser diode (41) is achieved, on the other hand, by introduction of an adhesive volume (51) between the end face of the carrier projection (14) and the front face of the heat conduction body (42), which is essentially parallel to the laser diode light emission surface and to the end face, with its wetting thereof. By solidification of the adhesive and its adhesion and cohesion forces, a material bond is achieved between the holding element (30) and the laser diode (41). Both fixing methods may be performed in arbitrary sequence or also simultaneously and end in sum with a fixation of the location of the fiber end surface (23) in relation to the laser diode (41).

The following dimensions may be cited to improve the comprehensibility: emitter width of the laser diode: 90 μm; fiber core diameter: 105 μm; fiber cladding diameter: 125 μm; fiber coating diameter: 250 μm; length of the first longitudinal groove section: 0.5 mm; length of the projection in the fiber axial direction: 0.5 mm, distance of the fiber end surface to the holding element in the fixed state: 0.5 mm.

Of course, neither this exemplary embodiment specifically nor the invention in general is bound to these dimension specifications. However, it has proven to be advantageous to keep the distance between the fiber end surface and the holding element in the fixed state less than 100 times, particularly preferably less than 20 times the fiber cladding diameter.

### Second Exemplary Embodiment

An exemplary embodiment of a light transmission apparatus according to the invention shown in FIG. 2 differs from the first exemplary embodiment in that the optical fiber (20) is free of the coating (21) only on a length reduced in relation to that in the first exemplary embodiment, which only extends over approximately 150% to 300% of the length of the first longitudinal groove section (11). While a coating-free fiber section is situated in the first longitudinal groove section (11), in contrast to the first exemplary embodiment, a fiber section subject to coating is now situated in the second longitudinal groove section (12). In the case of a fastening of the fiber (20) on the carrier (10) after completed alignment, a material bond is set up by an adhesive (50) to a fixing section of the fiber (20), which, because of the coating (21), is substantially more flexible than the coating-free fixing section of the optical fiber (20) in the first exemplary embodiment. The fiber section of the second exemplary embodiment, which protrudes from the fixation (50) in the direction facing away from the fiber end surface (23), is significantly less sensitive to breaking and bending than that of the first exemplary embodiment.

In addition, the carrier (10) is manufactured from metal and the holding element (30) is manufactured by introducing a liquid solder, preferably a soft solder, into the first longitudinal groove section (11). The solder forms a material bond with the metal carrier (10), while it does not wet the glass of the fiber cladding (22).

The laser diode assembly (40) has, in addition to the laser diode (41), an electrically conductive, metallic heat conduction body (42), which, for the contacting of the first contact surface of the laser diode (41), has a material bond thereto. An electrical terminal element (45) having opposite polarity to the heat conduction body is fastened on the second contact surface of the laser diode.

The connection (51) between the holding assembly (31) and the laser diode assembly (40) is produced by two solder drops (51), heated using a laser, between the end face of the carrier projection (14) and the front face of the heat conduction body (42).

### Third Exemplary Embodiment

The third exemplary embodiment shown in FIG. 3 illustrates the integration of the structural unit made of optical fiber (20), holding assembly (31), and laser diode assembly (40) of the first exemplary embodiment in a housing (60), of which only the housing floor plate (61), the housing wall (62), and the fiber feed-through (64) are shown. The connection of the structural unit to the housing floor plate (61) is performed by the soldering of the heat conduction body (42) on the housing floor plate (61), the heat conduction body being situated inside the housing wall (62). This soldering step of the production of the holding element (30) is preceded by the alignment, positioning, and fixation of the fiber end surface (23) and the carrier (10). While the transverse alignment of the fiber end surface (23) by movement of the carrier (10) in the x and y directions occurs inside the housing wall (20), the axial alignment of the fiber end surface (23) is performed by the mechanical coupling of a displacement and/or rotational apparatus to a coupling section of the optical fiber (20), which is situated outside the housing wall (62).

In addition to the fixation of the optical fiber (20) on the carrier in the area of a first, coating-free fixing section similarly to the first exemplary embodiment, the optical fiber (20) is fastened in the fiber feed-through (64) in the area of a second fixing section, which has coating, in that an adhesive is poured into a radially oriented opening (65), which extends from the outer lateral surface of to the inner lateral surface of the cavity of the fiber feed-through (64) which guides the optical fiber (20).

To explain the power conduction to the laser diode assembly (40), it is to be noted that two electrical conductors (70, 71) having opposing polarity are led from the outside through the housing wall and end inside the housing wall at two electrically conductive support points (72, 73). Electrical connection elements (74, 75) connect the support points (72, 73) to the electrical terminal surfaces (43, 44) of the laser diode assembly (40).

Finally, it is to be emphasized that the special features of the exemplary embodiments in no way restrict the scope of the invention. In particular, the features of various exemplary embodiments may be combined and/or combined with other features of light transmission apparatuses known in the prior art without leaving the context of the invention.

### LIST OF REFERENCE NUMERALS

10 carrier
11 longitudinal groove, first section
12 longitudinal groove, second section
13 transverse groove
14 projection
20 optical fiber
21 fiber coating
22 fiber cladding
23 light transmission surface/fiber end surface
30 holding element
31 holding assembly
40 laser diode assembly
41 reference object/laser diode
42 heat conduction body
43 first electrical terminal surface
44 second electrical terminal surface
45 electrical terminal element
50 joining agent/connection between optical fiber (20) and carrier (10)
51 joining agent/connection between carrier (10) and laser diode assembly (40)
60 housing
61 housing floor plate
62 housing wall
64 fiber feed-through
65 opening in fiber feed-through
70 first electrical conductor
71 second electrical conductor
72 first electrically conductive support point
73 second electrically conductive support point
74 first electrical connection element
75 second electrical connection element

What is claimed is:

1-21. (canceled)

22. A method for producing a light transmission apparatus, comprising:
providing an aperture in a holding element, the aperture defined at least partially by molding of at
least one outer contour section of an optical fiber;
disposing a guide section of the optical fiber in the aperture in the holding element;
changing a location of a light transmission surface of the optical fiber with respect to the holding element by executing at least one longitudinal sliding movement of a guide section of the optical fiber; and
fixating the holding element and the light transmission surface of the optical fiber with respect to
a reference object.

23. The method according to claim 22, further comprising changing a location of the light transmission surface of the optical fiber with respect to the reference object by executing at least one movement of the holding element in a direction perpendicular to the longitudinal axis of the optical fiber.

24. The method according to claim 22, wherein the longitudinal sliding movement occurs without a substantial location change of the holding element with respect to the reference object.

25. The method according to claim 22, wherein the guide section of the optical fiber has an essentially constant cross-section perpendicular to the longitudinal axis and the sliding movement includes a displacement of the guide section of the optical fiber in the longitudinal direction.

26. The method according to claim 22, wherein the guide section of the optical fiber comprises a generally cylindrical cross-section perpendicular to the longitudinal axis, wherein the sliding movement includes a rotation of the guide section of the optical fiber around the longitudinal axis, and wherein at least one of the light transmission surface and at least one of the fiber core of the optical fiber having a non-rotationally-symmetric shape, the optical fiber having a non-rotationally-symmetric optical property and the optical fiber comprising multiple fiber cores.

27. The method according to claim 22, wherein the outer contour section is formed by an outer lateral surface of a fiber cladding of the optical fiber.

28. The method according to claim 22, further comprising solidification of a material enclosing the outer contour section of the optical fiber.

29. The method according to claim 28, wherein the material is selected from a member of the group consisting of adhesive and solder.

30. The method according to claim 28, wherein the holding element is a section of a fiber coating of the optical fiber that has been removed from the fiber cladding.

31. The method according to claim 28, wherein before the molding step, at least the outer contour section of the optical fiber is subjected to a passivation method for at least one of preventing the occurrence of a material bond of the optical fiber to a surrounding substance and weakening a material bond of the optical fiber to the surrounding substance.

32. The method according to claim 22, wherein the molding of the outer contour section of the optical fiber is accompanied by at least one of a friction lock and material bond between the holding element and the optical fiber, and the method further comprises at least one of weakening and cancelling out of the friction lock or material bond.

33. The method according to claim 22, further comprising fastening of a fixation section of the optical fiber on a component that is mechanically connected to the reference object, wherein the fixations each contain at least one material bond between the fixation partners.

34. The method according to claim 22, wherein the fixation of the location of the light transmission surface with respect to the reference object is performed at least by the fixation of the holding element with respect to the reference object and at least by the fastening of a fixing section of the optical fiber on the holding element.

35. The method according to claim 22, wherein the holding element predominantly comprises a solidifying substance with respect to at least one of its volume and its mass, and a holding assembly includes the holding element and a carrier, wherein a material bond exists between the holding element and the carrier.

36. The method according to claim 35, wherein the fixation of the location of the light transmission surface with respect to the reference object is performed at least by the fixation of the holding element with respect to the reference object and at least by the fastening of a fixing section of the optical fiber on the carrier.

37. The method according to claim 22, wherein the reference object, the holding element, and the light transmission surface are at least partially situated in a shared housing, and are fastened on a housing component of the shared housing.

38. The method according to claim 37, wherein changing the location of the light transmission surface of the optical fiber with respect to the holding element includes manipulating a structure located external to the shared housing.

39. The method according to claim 37, wherein fixating the holding element and the light transmission surface of the optical fiber with respect to the reference object includes fastening of a fixing section of the optical fiber on a fiber feed-through.

40. The method according to claim 22, wherein the reference object is a laser diode element and the light transmission surface of the optical fiber is a light entry surface on a fiber end surface.

41. A light transmission apparatus comprising:
an optical fiber including a light transmission surface, a guide section and an outer contour section;
a holding element including an aperture defined therein, the aperture having a shape corresponding to the outer contour section of the optical fiber and being at least partially formed by molding; wherein at least a portion of the guide section is disposed in the aperture of the holding element; and
a reference object disposed in a fixed position relative to the light transmission surface of the optical fiber and the holding element.

42. The light transmission apparatus according to claim 41, wherein the reference object is a laser diode assembly.
